(19) United States
(12) Patent Application Publication
(10) Pub. No.: US 2010/0092755 A1
(43) Pub. Date: Apr. 15, 2010

(54) FILMS HAVING IMPROVED PROPERTIES

(75) Inventors: Heinz Pudleiner, Krefeld (DE); Klaus Meyer, Dormagen (DE); Joerg Nickel, Dormagen (DE); Hans Braun, Rayong (TH)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/542,973

(22) Filed: Aug. 18, 2009

(30) Foreign Application Priority Data
Aug. 19, 2008 (EP) 08400040.5

(51) Int. Cl. C10M 105/72; B32B 27/00

(52) U.S. Cl. 428/220; 508/100; 428/339

(57) ABSTRACT

The invention relates to films having good sliding friction properties and gloss values, consisting of a plastics composition comprising from 96 to 99.499 wt. % of a transparent polycarbonate and from 0.001 to 4 wt. % quaternary ammonium salts of perfluoroalkylsulfonic acids as lubricant additive and from 0.5 to 29.999 wt. % barium sulfate, the sum of the mentioned constituents in each case being 100 wt. %. The films exhibit improved properties in processing. The invention relates further to mouldings produced from these films.

### RELATED APPLICATIONS

This application claims benefit to European Patent Application No. 08400040.5, filed Aug. 19, 2008, which is incorporated herein by reference in its entirety for all useful purposes.

### BACKGROUND OF THE INVENTION

The present invention relates to films which have good sliding friction and antistatic properties and at the same time have outstanding gloss values. In addition, the films according to the invention exhibit improved properties in processing.

For many applications, films are cut to size and processed further in the form of sheets and webs. This is the case, for example, in the printing or lamination of the films. The films are cut to size and must be separated into individual sheets for the subsequent processing step. This gives rise to not inconsiderable problems due inter alfa to electrostatic charge and, in addition, the so-called “wet-out effect”. The cut pieces of film tend to stick together, for example, which leads to disruptions in the production sequence. The effect of the films sticking together during processing is also referred to as “blocking”.

In most uses of films and film production processes it is therefore important that the films have good antistatic properties and, in addition, good sliding friction properties, that is to say possess as low a coefficient of sliding friction as possible, in order to avoid blocking.

Thermoplastic plastics are widely used, for example, for packaging purposes. For some applications it is therefore also necessary for the films additionally to exhibit high gloss values.

EP 0 862 594 B1 describes a release film comprising a substrate of a film-forming polymeric material, for example of a polycarbonate, to which a release composition is applied. The release composition contains a mixture of a curable silicone resin and a curable polyurethane resin.

From GB 1 398 359 there are known coatings which contain cellulose esters or a silicone oil as additives. The application of such coatings to films means an additional processing step and is therefore cost-intensive. Moreover, additives such as silicone oils change the surface properties in such a manner that trouble-free printing of the films can no longer be ensured.

U.S. Pat. No. 3,424,703 describes polycarbonate films having a low coefficient of sliding friction. These polycarbonates contain as lubricants inorganic talc or silica particles, which can act as “spacers” between the film sheets. Although these particles prevent the “wet-out effect”, they are not effective against electrostatic charge.

In EP 1 232 206, quaternary ammonium salts are described as antistatic compositions. However, when used in polycarbonates they result in a marked yellowing during processing, which is undesirable in particular for transparent and white-coloured formulations of polymeric moulded bodies and extrudates.

Quaternary ammonium salts of perfluoroalkylsulfonic acids and their use as additives for thermoplastics are known. For example, DE 2 506 726 describes quaternary ammonium salts of perfluoroalkylsulfonic acids as demoulding agents for polycarbonates. In DE 100 19 416 A1, specific perfluoroalkylsulfonic acid ammonium salts are used as antistatics in thermoplastic moulding compositions.

The various fields of use make high demands of the processability and further properties of the films. It has been found that the antiblocking agents or antiblocking agent compositions known hitherto can have adverse effects on other film properties. For example, the transparency and gloss of the films in particular are impaired by lubricants or the additive compositions.

Accordingly, it is an object of the invention to provide films which, both with smooth and with textured surfaces, move relative to one another and can be separated without difficulty and at the same time have good gloss values, and with which the problem of the separation of film sheets can be avoided.

### EMBODIMENTS OF THE INVENTION

An embodiment of the present invention is a film comprising a plastics composition which comprises (a) from 70 to 99.499 weight % of a transparent polycarbonate; (b) from 0.001 to 4 weight % a quaternary ammonium salt of a perfluoroalkylsulfonic acid as lubricant additive; and (c) from 0.5 to 29.999 weight % of barium sulfate, wherein the sum of (a), (b), and (c) equals 100 weight %.

Another embodiment of the present invention is the above film, wherein said quaternary ammonium salt of a perfluoroalkylsulfonic acid is of formula (I)

R—SO₃ NR′R″R′″R″″ (I)
wherein
R is a perfluorinated cyclic or linear, branched or unbranched carbon chain having from 1 to 30 carbon atoms;
R′ in an unsubstituted or halo-, hydroxy-, cycloalkyl-, or alkyl-substituted, cyclic or linear, branched or unbranched carbon chain having from 1 to 30 carbon atoms;
R″, R′″, R″″
   are, each independently of one another, unsubstituted or halo-, hydroxy-, cycloalkyl-, or alkyl-substituted, cyclic or linear, branched or unbranched carbon chains having from 1 to 30 carbon atoms;
      with the proviso that at least one of R′, R″, R′″, and R″″ is not ethyl.

Another embodiment of the present invention is the above film, wherein said quaternary ammonium salt of a perfluoroalkylsulfonic acid is selected from the group from the group consisting of:
perfluorooctaneesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethylneopentylammonium salt,
perfluorooctanesulfonic acid dimethyldiisopropylammonium salt,
perfluorooctanesulfonic acid trimethylneopentylammonium salt,
perfluorobutanesulfonic acid dimethyldineopentylammonium salt,
perfluorooctanesulfonic acid dimethyldineopentylammonium salt,
N-methyl-tripropylammonium perfluorobutylsulfonate,
N-ethyl-tripropylammonium perfluorobutylsulfonate,
tetrapropylammonium perfluorobutylsulfonate,
dimethyldiisopropylammonium perfluorobutylsulfonate,
N-methyl-tributylammonium perfluorooctylsulfonate,
cyclohexyldiethylmethylammonium perfluorooctylsulfonate, and
cyclohexyltrimethylammonium perfluorooctylsulfonate.

Another embodiment of the present invention is the above film, wherein said quaternary ammonium salt of a perfluoroalkylsulfonic acid is diisopropyldimethylammonium perfluorobutylsulfonate.

Another embodiment of the present invention is the above film, wherein said film has a thickness in the range of from 50 μm to 1000 p.m.

Another embodiment of the present invention is the above film, wherein said film comprises at least one coextruded layer.

Another embodiment of the present invention is the above film, wherein said coextruded layer has a thickness in the range of from 10 to 100 p.m.

Yet another embodiment of the present invention is a moulding comprising the above film.

### DESCRIPTION OF THE INVENTION

That object is achieved according to the invention by a film according to claim 1, which consists of a plastics composition comprising from 70.000 to 99.499 wt. % of a transparent polycarbonate and from 0.001 to 4.000 wt. % quaternary ammonium salts of perfluoroalkylsulfonic acids as lubricant additive and from 0.500 to 29.999 wt. % barium sulfate, the sum of the mentioned constituents in each case being 100 wt. %.

The barium sulfate used has a mean particle size of from 0.5 to 10 μm, preferably from 1 to 5 μm.

It has been found, surprisingly, that plastics compositions comprising from 70.000 to 99.499 wt. % of a transparent polycarbonate, from 0.001 to 4.000 wt. % quaternary ammonium salts of perfluoroalkylsulfonic acids as internal lubricant additive and from 0.500 to 29.999 wt. % barium sulfate are particularly suitable for the production of such films. The films according to the invention can be moved relative to one another and separated without difficulty both with smooth and with textured surfaces. The films have good sliding friction and antistatic properties. In addition, they have outstanding gloss values. An additional coating, which would mean an additional process step, is not necessary.

The films according to the invention can preferably exhibit coefficients of friction of less than 0.3 in the case of a smooth surface, that is to say in the case of a roughness (Rz according to ISO 4288) of less than 100 nm, measured according to ASTM D 1894-06, and less than 0.25 in the case of a roughness (Rz according to ISO 4288) greater than 5 μm, measured according to ASTM D 1894-06. The coefficients of friction are here meant on identical surfaces of the films.

Suitable polycarbonates for the production of the films according to the invention are any known polycarbonates. These are homopolycarbonates, copolycarbonates and thermoplastic polyester carbonates.

The polycarbonates preferably have a weight-average molecular weight M̅w of from 18,000 to 40,000, preferably from 26,000 to 36,000 and particularly preferably from 28,000 to 35,000, determined by measuring the relative solution viscosity in an Ubbelohde viscometer at 25° C. in dichloromethane or in mixtures of equal amounts by weight of phenol/o-dichlorobenzene, calibrated by light scattering.

The polycarbonates can be prepared by known methods, for example by the interfacial process or the melt transesterification process.

The preparation of polycarbonates by the interfacial process has been described many times in the literature; reference may be made, for example, to H. Schnell, Chemistry and Physics of Polycarbonates, Polymer Reviews, Vol. 9, Interscience Publishers, New York 1964 p. 33 ff, Polymer Reviews, Vol. 10, “Condensation Polymers by Interfacial and Solution Methods”, Paul W. Morgan, Interscience Publishers, New York 1965, Chap. Vm, p. 325, Dres. U. Grigo, K. Kircher and P. R- Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145 as well as to patent specification EP 0 517 044 A.

In addition, polycarbonates can also be prepared from diaryl carbonates and diphenols by the known polycarbonate process in the melt, the so-called melt transesterification process, which is described, for example, in WO-A 01/05866 and WO-A 01/05867. Transesterification processes (acetate process and phenyl ester process) are additionally described, for example, in U.S. Pat. No. 3,494,885; U.S. Pat. No. 4,386,186; U.S. Pat. No. 4,661,580; U.S. Pat. No. 4,680,371 and U.S. Pat. No. 4,680,372, as well as in EP-A 26 120, EP-A 26 121, EP-A 26 684, EP-A 28 030, EP-A 39 845, EP-A 91 602, EP-A 97 970, EP-A 79 075, EP-A 14 68 87, EP-A 15 61 03, EP-A 23 49 13 and EP-A 24 03 01 as well as in DE-A 14 95 626.

Suitable diphenols are described, for example, in U.S. Pat. Nos. 2,999,835; 3,148,172; 2,991,273; 3,271,367; 4,982,014 and 2,999,846; in German Offenlegungsschriften 1 570 703, 2 063 050, 2 036 052, 2 211 956 and 3 832 396, in French patent specification 1 561 518, in the monograph “H. Schnell, Chemistry and Physics of Polycarbonates, Interscience Publishers, New York 1964, p. 28ff; p. 102ff, and in “D. G. Legrand, J. T. Bendler, Handbook of Polycarbonate Science and Technology, Marcel Dekker New York 2000, p. 72ff”.

Both homopolycarbonates and copolycarbonates can be used according to the invention. For the preparation of copolycarbonates it is possible according to the invention to use as one component also from 1 to 25 wt. %, preferably from 2.5 to 25 wt. % (based on the total amount of diphenols to be used), of polydiorganosiloxanes having hydroxy-aryloxy end groups. These are known, for example, from U.S. Pat. No. 3,419,634 or can be prepared by processes known in the literature. The preparation of polydiorganosiloxane-containing copolycarbonates is described, for example, in Offenlegungsschrifl DE 33 34 782 A.

It is further possible according to the invention to use polyester carbonates and block copolyester carbonates, as are described, for example, in WO 2000/26275. Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

The aromatic polyester carbonates can be both linear and branched in a known manner, as described, for example, in DE 29 40 024 A and DE 30 07 934 A.

In a form that is preferred according to the invention, there can be used as lubricant additive one or more quaternary ammonium salts of a perfluoroalkylsulfonic acid of formula (I)

R—SO₃ NR′R″R′″R″″ (I)
wherein
R denotes perfluorinated cyclic or linear, branched or unbranched carbon chains having from 1 to 30 carbon atoms, preferably from 4 to 8 carbon atoms, in the case of cyclic radicals preferably those having from 5 to 7 carbon atoms;
R′ denotes unsubstituted or halo-, hydroxy-, cycloalkyl- or alkyl-substituted, in particular C₁- to C₃-alkyl- or C₅- to C₇-cycloalkyl-substituted, cyclic or linear, branched or unbranched carbon chains having from 1 to 30 carbon atoms, preferably from 3 to 10 carbon atoms, in the case of cyclic radicals preferably those having from 5 to 7 carbon atoms, particularly preferably propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl;
R″, R′″, R″″ each independently of the others denotes unsubstituted or halo-, hydroxy-, cycloalkyl- or alkyl-substituted, in particular C₁- to C₃-alkyl- or C₅- to C₇-cycloalkyl-substituted, cyclic or linear, branched or unbranched carbon chains having from 1 to 30 carbon atoms, preferably from 1 to 10 carbon atoms, in the case of cyclic radicals preferably those having from 5 to 7 carbon atoms, particularly preferably methyl, ethyl, propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl;
with the proviso that at least one of the radicals R′ to R″″ does not represent ethyl.

A preferred choice is the ammonium salts wherein
R denotes perfluorinated linear or branched carbon chains having from 1 to 30 carbon atoms, preferably from 4 to 8 carbon atoms;
R′ denotes halogenated or non-halogenated linear or branched carbon chains having from 1 to 30 carbon atoms, preferably from 3 to 10 carbon atoms, particular preference being given to propyl, 1-butyl, 1-pentyl, hexyl, isopropyl, isobutyl, tert-butyl, neopentyl, 2-pentyl, isopentyl, isohexyl, and

R″, R′″, R″″ each independently of the others denotes halogenated or non-halogenated linear or branched carbon chains having from 1 to 30 carbon atoms, preferably from 1 to 10 carbon atoms, particular preference being given to methyl, ethyl, propyl, 1-butyl, 1-pentyl, hexyl, isopropyl, isobutyl, tert-butyl, neopentyl, 2-pentyl, isopentyl, isohexyl,

with the proviso that at least one of the radicals R′ to R″″ does not represent ethyl.

Particularly preferred quaternary ammonium salts as lubricant additives within the scope of the invention are
perfluorooctaneesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethylneopentylammonium salt,
perfluorooctanesulfonic acid dimethyldiisopropylammonium salt,
perfluorooctanesulfonic acid trimethylneopentylammonium salt,
perfluorobutanesulfonic acid dimethyldineopentylammonium salt,
perfluorooctanesulfonic acid dimethyldineopentylammonium salt,
N-methyl-tripropylammonium perfluorobutylsulfonate,
N-ethyl-tripropylammonium perfluorobutylsulfonate,
tetrapropylammonium perfluorobutylsulfonate,
dimethyldiisopropylammonium perfluorobutylsulfonate,
N-methyl-tributylammonium perfluorooctylsulfonate,
cyclohexyldiethylmethylammonium perfluorooctylsulfonate,
cyclohexyltrimethylammonium perfluorooctylsulfonate.

According to the invention it is possible to use one or more of the above-mentioned quaternary ammonium salts, that is to say also mixtures, as lubricant additive.

The lubricant additive(s) according to the invention is/are preferably selected from the group

perfluorooctanesulfonic acid tetrapropylammonium salt,
perfluorooctanesulfonic acid tetrabutylammonium salt,
perfluorooctanesulfonic acid tetrapentylammonium salt,
perfluorooctanesulfonic acid tetrahexylammonium salt,
perfluorooctanesulfonic acid dimethyldiisopropylammonium salt and
cyclohexyltrimethylammonium perfluorooctylsulfonate, and the corresponding perfluorobutane-sulfonic acid salts.

In a most particularly preferred embodiment of the invention, perfluorobutanesulfonic acid dimethyldiisopropylammonium salt can be used as lubricant additive.

Perfluoroalkylsulfonic acid ammonium salts are known or can be prepared according to known methods. Preparation processes are described, for example, in WO 01/85869, DE 1 966 931 or NL 7 802 830.

The perfluoroalkylsulfonic acid ammonium salts as lubricant additive(s) are added to the polycarbonates in amounts of from 0.001 to 4.000 wt. %, preferably from 0.001 to 3.500 wt. %, particularly preferably from 0.050 to 1.000 wt. %, most particularly preferably from 0.1 to 0.5 wt. %. This amount of lubricant additive is made up to 100 wt. % with the amounts of barium sulfate and polycarbonate in the plastics composition.

Barium sulfate is added to the polycarbonates in amounts of from 0.500 to 29.999 wt. %, preferably from 0.500 to 14.999 wt. %, particularly preferably from 0.500 to 3.999 wt. %, most particularly preferably from 2.0 to 3.5 wt. %. This amount of barium sulfate is made up to 100 wt. % with the amounts of lubricant additive and polycarbonate in the plastics composition.

The plastics composition contains transparent polycarbonate in amounts of from 70.000 to 99.499 wt. %, preferably from 85.000 to 99.499 wt. %, particularly preferably from 96.000 to 99.450 wt. %, most particularly preferably from 96.0 to 97.9 wt. %. This amount of polycarbonate is made up to 100 wt. % with the amounts of lubricant additive and barium sulfate in the plastics composition.

Additional conventional polymer additives can optionally be present according to the invention in the plastics compositions of the films according to the invention. For example, UV absorbers as well as conventional processing aids, in particular demoulding agents and flow improvers, as well as, for example, stabilisers known for polycarbonates, in particular heat stabilisers, antistatics and/or optical brighteners can be present.

In a further preferred embodiment of the invention, the plastics composition of the polycarbonate film can contain from 0.01 to 0.5 wt. %, based on the total amount of the plastics composition, of a UV absorber selected from the classes of the benzotriazole derivatives, dimeric benzotriazole derivatives, triazine derivatives, dimeric triazine derivatives, diaryl cyanoacrylates.

According to the invention there can be used as stabilisers, for example, phosphines, phosphites or Si-containing stabilisers and further compounds described in EP-A 0 500 496. Examples of stabilisers which may be mentioned include triphenyl phosphites, diphenylalkyl phosphites, phenyldialkyl phosphites, tris-(nonylphenyl) phosphite, tetrakis-(2,4-di-tert-butylphenyl)-4,4′-biphenylene diphosphonite, bis(2,4-dicumylphenyl)pentaerythritol diphosphite and triaryl phosphite. Particular preference is given to the use of triphenylphosphine and tris-(2,4-di-tert-butylphenyl)phosphite as stabilisers.

The lubricant additives and further additives mentioned above can be incorporated in a known manner by mixing polymer granules with the additives at temperatures of approximately from 200 to 350° C. in conventional devices such as internal kneaders, single-screw extruders and twin-screw extruders, for example by melt compounding or melt extrusion or by mixing the solutions of the polymer with solutions of the additives in suitable organic solvents such as CH₂Cl₂, haloalkanes, haloaromatic compounds, chlorobenzene and xylenes and then evaporating off the solvents in a known manner. The amount of additives in the moulding composition can be varied within wide limits and is governed by the desired properties of the moulding composition.

The films according to the invention can be produced by extrusion, for example. However, they can additionally also be cast from solutions in the form of cast films.

The thickness of the films according to the invention can preferably be from 50 μm to 1000 μm, particularly preferably from 70 μm to 800 μm and most particularly preferably from 100 μm to 700 μm. Depending on the field of application and the demands in question, smaller or larger thicknesses of the films can also be produced.

In order to produce the films by extrusion, polycarbonate granules are fed to the hopper of an extruder and pass via the hopper into the plastification system of the extruder, which consists of a screw and a cylinder. In the plastification system, the granules are fed and melted. The molten plastics material is pressed through a flat-sheet die and thereby deformed, is brought into the desired final form in the roll gap of a smoothing calender, and its form is fixed by alternate cooling on smoothing rolls and in the ambient air. Between the plastification system and the flat-sheet die there can be arranged a filter device, a melt pump, stationary mixing elements and further components.

The polycarbonates having high melt viscosity which are used for the extrusion are conventionally processed at melt temperatures of from 260 to 320° C., the cylinder temperatures of the plastification cylinder and the die temperatures being set accordingly.

According to the invention, the extrudates in one embodiment can also be composed of a plurality of layers. For example, it is possible according to the invention for a film to be composed of at least one base layer and at least one coextruded layer.

By the use of one or more lateral extruders and suitable melt adapters upstream of the flat-sheet die it is possible to place polycarbonate melts of different compositions one above the other and thus produce, for example, multilayer extrudates, such as films or sheets, as are described, for example, in EP 0 110 221 A and EP 0 110 238 A.

Both the base layer and any coextruded layer(s) of the films according to the invention can additionally contain additives such as, for example, UV absorbers as well as other conventional processing aids, in particular demoulding agents and flow improvers, as well as stabilisers conventional for polycarbonates, in particular heat stabilisers, and also antistatics and optical brighteners. Different additives or concentrations of additives can be present in each layer.

In a preferred embodiment, the at least one coextruded layer can have a thickness of from 10 to 100 μm.

In particular, the coextruded layer can contain, in addition to the lubricant additive and the barium sulfate, also UV absorbers and demoulding agents.

The following examples are intended to illustrate the invention without limiting it.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Film Extrusion

The system used for producing the films by extrusion consists of
a main extruder with a screw having a diameter (D) of 105 mm and a length of 41×D; the screw has a degassing zone;
a flat-sheet extrusion die having a width of 1500 mm;
a three-roll smoothing calender in which the rolls are arranged horizontally, the third roll being pivotable by +/−45° relative to the horizontal;
a roller conveyor;
a device for applying protective film to both sides;
a take-off device, and
a winding station.

The granules in question were fed to the hopper of the extruder. The material was melted and conveyed in the cylinder/screw plastification system of the extruder. The molten material was fed to the smoothing calender, the rolls of which had the temperature indicated in Table 1. Final forming and cooling of the film took place on the smoothing calender (consisting of three rolls). For texturing the film surfaces, a rubber roll (no. 4 surface), a polished chrome roll (no. 1 surface) or a textured steel roll (no. 2 surface) was used in order to produce the desired texturing of the film surfaces. The rubber roll used for texturing the film surface is disclosed in U.S. Pat. No. 4,368,240 of Nauta Roll Corporation. The film was then transported by a take-off device.

The following process parameters were chosen:

TABLE 1

| Temperature of the main extruder | 275° C. +/− 5° C. | |
|---|---|---|
| Temperature of the coextruder | 260° C. +/− 5° C. | |
| Temperature of the deflection head | 285° C. +/− 5° C. | |
| Temperature of the die | 300° C. +/− 5° C. | |
| Speed of the main extruder | 45 | min⁻¹ |
| Speed of the coextruder | 12 | min⁻¹ |
| Temperature of the rubber roll 1 | 24° | C. |
| Temperature of roll 2 | 72° | C. |
| Temperature of roll 3 | 131° | C. |
| Take-off speed | 21.5 | m/min |

The preparation of the compounds was carried out using conventional twin-screw compounding extruders (e.g. ZSK 32) at processing temperatures conventional for polycarbonate of from 250 to 330° C.

### Example 1

### Preparation of the White (BaSO₄) Masterbatch

A masterbatch having the following composition was prepared:
Polycarbonate Makrolon 3108 550115 from Bayer MaterialScience AG in an amount of 70 wt. %
Barium sulfate having a particle size of from 2 to 15 μm and a mean particle size of 9 μm (for example Velvolux K3 from Sachtleben) in an amount of 30 wt. %.

### Example 2

### Preparation of the Lubricant Additive Masterbatch

A masterbatch having the following composition was prepared:
Polycarbonate Makrolon 2600 000000 from Bayer MaterialScience AG in an amount of 98 wt. %
Diisopropyldimethylammonium perfluorobutanesulfonate in the form of a colourless powder in an amount of 2 wt. %.

### Comparison Example 3

A compound having the following composition was blended:

Polycarbonate Makrolon 3108 550115 from Bayer MaterialScience AG in an amount of 100 wt. %.

Two chrome rolls were used in the smoothing device, and a film having a thickness of 375 μm with a smooth surface on both sides (so-called 1-1 surface) was produced.

### Comparison Example 4

A compound having the following composition was blended:
Polycarbonate Makrolon 3108 550115 from Bayer MaterialScience AG in an amount of 90.0 wt. %
Lubricant additive masterbatch according to Example 2 in an amount of 10.0 wt. %.

Two chrome rolls were used in the smoothing device, and a film having a thickness of 375 μM with a smooth surface on both sides (so-called 1-1 surface) was produced.

### Example 5

### According to the Invention

A compound having the following composition was blended:
Polycarbonate Makrolon 3108 550115 Bayer MaterialScience AG in an amount of 83.0 wt. %
Masterbatch according to Example 2 in an amount of 10.0 wt. %
Masterbatch according to Example 1 in an amount of 7.0 wt. %.

A matt steel roll and a rubber roll were used in the smoothing device, and a film having a thickness of 375 μm with a so-called 4-2 surface was produced.

### Comparison Example 6

A compound having the following composition was blended:
Polycarbonate Makrolon 3108 550115 Bayer MaterialScience AG in an amount of 93.0 wt. %
Masterbatch according to Example 1 in an amount of 7.0 wt. %

A matt steel roll and a rubber roll were used in the smoothing device, and a film having a thickness of 375 μm with a so-called 4-2 surface was produced.

### Comparison Example 7

A compound having the following composition was blended:
Polycarbonate Makrolon 3108 550115 Bayer MaterialScience AG in an amount of 100.0 wt. %.

A matt steel roll and a rubber roll were used in the smoothing device, and a film having a thickness of 375 μm with a 4-2 surface was produced.

### Roughness Measurements

The roughness was determined in accordance with standard ISO 4288.

| | | Roughness | Roughness |
|---|---|---|---|
| | | (no. 1 or | (no. 1 or |
| | Surfaces | no. 4 side) | no. 2 side) |
| Example 3 | 1-1 | <1 μm | <1 μm |
| Example 4 | 1-1 | <1 μm | <1 μm |
| Example 5 | 4-2 | 6.7 μm (no. 4) | 6.0 μm (no. 2) |
| (according to | | | |
| the invention) | | | |
| Example 6 | 4-2 | 8.1 μm (no. 4) | 7.8 μm (no. 2) |
| Example 7 | 4-2 | 5.9 μm (no. 4) | 5.06 μm (no. 2) |

### Measurements of the Degree of Gloss

The degree of gloss was determined in accordance with standard EN ISO 2813 (60° angle).

| | | Degree of gloss | Degree of gloss |
|---|---|---|---|
| | | (no. 1 or | (no. 1 or |
| | Surfaces | no. 4 side) | no. 2 side) |
| Example 3 | 1-1 | >90 | >90 |
| Example 4 | 1-1 | >90 | >90 |
| Example 5 | 4-2 | 6.1-6.7 (no. 4) | 93.1 (no. 2) |
| (according to | | | |
| the invention) | | | |
| Example 6 | 4-2 | 3.5-5.3 (no. 4) | 85.2-87.4 (no. 2) |
| Example 7 | 4-2 | 7.0-8.3 (no. 4) | 10.3-18.1 (no. 2) |

### Determination of the Coefficients of Friction:

The coefficient of friction was determined in accordance with standard ASTM D 1894-06. The sides of the films having comparable roughness values were rubbed together.

Conditions:

| Measuring temperature: | 23° C. | |
|---|---|---|
| Friction block | 50 mm | |
| Weight (friction block) | 202.2 g | |
| Sliding speed | 100 mm/min | |
| Test specimen: | width: | 60 mm |
| | length: | 200 mm |

| | | Co- |
|---|---|---|
| | | efficient |
| | | of sliding |
| Combination of the sides rubbed together | | friction |
| Film of Example 3/no. 1 side | Film of Example 3/no. 1 side | >2.52* |
| Film of Example 4/no. 1 side | Film of Example 4/no. 1 side | 0.3 |
| Film of Example 5/no. 2 side | Film of Example 5/no. 2 side | 0.21 |
| Film of Example 6/no. 2 side | Film of Example 6/no. 2 side | 1.51 |
| Film of Example 7/no. 2 side | Film of Example 7/no. 2 side | 0.23 |
| Film of Example 5/no. 4 side | Film of Example 5/no. 4 side | 0.12 |
| Film of Example 6/no. 4 side | Film of Example 6/no. 4 side | 0.25 |
| Film of Example 7/no. 4 side | Film of Example 7/no. 4 side | 0.29 |

*outside the maximum measuring range

It was found that the films produced from a plastics composition according to the invention comprising polycarbonate, diisopropyldimethylammonium perfluorobutanesulfonate and barium sulfate (Example 5) exhibit very good gloss values and the best coefficients of sliding friction.

In addition, the films according to the invention also exhibit surprisingly good properties in further processing, for example in the production of mouldings using films of the same or different plastics compositions or in the production of composite bodies with other materials. If the films according to the invention are formed and made into mouldings, overhanging material must often be separated off. This operation is also referred to as “trimming”. Cutting tests on the cut-off edge have shown that the edge of the film in the case of the films according to the invention is markedly smoother and more uniform than in the case of films of the prior art. The invention relates also to such mouldings or composite bodies which contain one or more films according to the invention or consist of films according to the invention, such as, for example, sheets.

1. A film comprising a plastics composition which comprises (a) from 70 to 99.499 weight % of a transparent polycarbonate; (b) from 0.001 to 4 weight % a quaternary ammonium salt of a perfluoroalkylsulfonic acid as lubricant additive; and (c) from 0.5 to 29.999 weight % of barium sulfate, wherein the sum of (a), (b), and (c) equals 100 weight %.

2. The film of claim 1, wherein said quaternary ammonium salt of a perfluoroalkylsulfonic acid is of formula (I)
R—SO₃ NR′R″R′″R″″ (I)
wherein
R is a perfluorinated cyclic or linear, branched or unbranched carbon chain having from 1 to 30 carbon atoms;
R′ in an unsubstituted or halo-, hydroxy-, cycloalkyl-, or alkyl-substituted, cyclic or linear, branched or unbranched carbon chain having from 1 to 30 carbon atoms;
R″, R′″, R″″
are, each independently of one another, unsubstituted or halo-, hydroxy-, cycloalkyl-, or alkyl-substituted, cyclic or linear, branched or unbranched carbon chains having from 1 to 30 carbon atoms;
with the proviso that at least one of R′, R″, R′″, and R″″ is not ethyl.

3. The film of claim 1, wherein said quaternary ammonium salt of a perfluoroalkylsulfonic acid is selected from the group from the group consisting of:
perfluorooctanesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethylneopentylammonium salt,
perfluorooctanesulfonic acid dimethyldiisopropylammonium salt,
perfluorooctanesulfonic acid trimethylneopentylammonium salt,
perfluorobutanesulfonic acid dimethyldineopentylammonium salt,
perfluorooctanesulfonic acid dimethyldineopentylammonium salt,
N-methyl-tripropylammonium perfluorobutylsulfonate,
N-ethyl-tripropylammonium perfluorobutylsulfonate,
tetrapropylammonium perfluorobutylsulfonate,
dimethyldiisopropylammonium perfluorobutylsulfonate,
N-methyl-tributylammonium perfluorooctylsulfonate,
cyclohexyldiethylmethylammonium perfluorooctylsulfonate, and
cyclohexyltrimethylammonium perfluorooctylsulfonate.

4. The film of claim 1, wherein said quaternary ammonium salt of a perfluoroalkylsulfonic acid is diisopropyldimethylammonium perfluorobutylsulfonate.

5. The film of claim 1, wherein said film has a thickness in the range of from 50 μm to 1000 μm.

6. The film of claim 1, wherein said film comprises at least one coextruded layer.

7. The film of claim 6, wherein said coextruded layer has a thickness in the range of from 10 to 100 μm.

8. A moulding comprising the film of claim 1.
